(19) United States
(12) Patent Application Publication
(10) Pub. No.: US 2026/0208790 A1
(43) Pub. Date: Jul. 23, 2026

(54) SYSTEMS AND METHODS FOR VEHICLE GRIP ASSIST

(71) Applicant: STEERING SOLUTIONS IP HOLDING CORPORATION, Saginaw, MI (US)

(72) Inventors: Arash Hosseinian Ahangarnejad, Canyon Country, CA (US); Peter D. Schmitt, Auburn Hills, MI (US)

(21) Appl. No.: 19/032,645

(22) Filed: Jan. 21, 2025

(51) Int. Cl. B62D 7/15

(52) U.S. Cl. CPC B62D 7/159

(57) ABSTRACT

A method includes determining a first slip angle of at least one roadwheel of a vehicle, determining whether the first slip angle is greater than or equal to a first slip angle threshold, and, in response to a determination that the first slip angle is greater than or equal to the first slip angle threshold, controlling at least one aspect of a steering system of the vehicle to maintain a steering angle. The method also includes determining a second slip angle of the at least one roadwheel of the vehicle, determining whether the second slip angle is greater than or equal to a second slip angle threshold, and, in response to a determination that the second slip angle is greater than or equal to the second slip angle threshold, controlling the at least one aspect of the steering system of the vehicle to decrease the steering angle.

### TECHNICAL FIELD

This disclosure relates to steering systems, and in particular, to systems and methods for vehicle grip assist.

### BACKGROUND

A vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an electronic power steering (EPS) system, a steer-by-wire (SbW) steering system, a hydraulic steering system, or other suitable steering system and/or other suitable systems (e.g., such as a braking system, propulsion system, and the like). Such systems of the vehicle typically controls various aspects of vehicle steering (e.g., including providing steering assist to an operator of the vehicle, controlling steerable wheels of the vehicle, and the like), vehicle propulsion, vehicle braking, and the like.

### SUMMARY

This disclosure relates generally to steering systems.

An aspect of the disclosed embodiments includes a method for vehicle stability control. The method includes determining a first slip angle of at least one roadwheel of a vehicle, determining whether the first slip angle is greater than or equal to a first slip angle threshold, and, in response to a determination that the first slip angle is greater than or equal to the first slip angle threshold, controlling at least one aspect of a steering system of the vehicle to maintain a steering angle. The method also includes determining a second slip angle of the at least one roadwheel of the vehicle, determining whether the second slip angle is greater than or equal to a second slip angle threshold, and, in response to a determination that the second slip angle is greater than or equal to the second slip angle threshold, controlling the at least one aspect of the steering system of the vehicle to decrease the steering angle.

Another aspect of the disclosed embodiments includes a system for vehicle stability control. The system includes a processor, and a memory. The memory includes instructions that, when executed by the processor, cause the processor to: determine a first slip angle of at least one roadwheel of a vehicle; determine whether the first slip angle is greater than or equal to a first slip angle threshold; in response to a determination that the first slip angle is greater than or equal to the first slip angle threshold, control at least one aspect of a steering system of the vehicle to maintain a steering angle; determine a second slip angle of the at least one roadwheel of the vehicle; determine whether the second slip angle is greater than or equal to a second slip angle threshold; and, in response to a determination that the second slip angle is greater than or equal to the second slip angle threshold, control the at least one aspect of the steering system of the vehicle to decrease the steering angle.

Another aspect of the disclosed embodiments includes an apparatus for vehicle stability control. The apparatus includes a controller configured to: in response to a determination that a first slip angle is greater than or equal to a first slip angle threshold, control at least one aspect of a steering system of the vehicle to maintain a steering angle; in response to a determination that a second slip angle is greater than or equal to a second slip angle threshold, control the at least one aspect of the steering system of the vehicle to decrease the steering angle; in response to a third slip angle being less than the first slip angle threshold, control the at least one aspect of the steering system of the vehicle to maintain the steering angle; in response to a determination that a fourth slip angle is greater than a third slip angle threshold, control the at least one aspect of the steering system of the vehicle to decrease the steering angle; and, in response to a determination that a fifth slip angle is less than the third slip angle threshold, control the at least one aspect of the steering system of the vehicle to increase the steering angle.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a vehicle according to the principles of the present disclosure.

FIG. 2 generally illustrates a controller according to the principles of the present disclosure.

FIG. 3 generally illustrates plot of roadwheel slip angles according to the principles of the present disclosure.

FIG. 4 is a flow diagram generally illustrating a vehicle stability control method according to the principles of the present disclosure

FIG. 5 is a flow diagram generally illustrating an alternative vehicle stability control method according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an EPS system, a SbW steering system, a hydraulic steering system, or other suitable steering system and/or other suitable systems (e.g., such as a braking system, propulsion system, and the like).

Such systems of the vehicle typically controls various aspects of vehicle steering (e.g., including providing steering assist to an operator of the vehicle, controlling steerable wheels of the vehicle, and the like), vehicle propulsion, vehicle braking, and the like. Occasionally during operation of a vehicle, various road conditions (e.g., such as wet or icy pavement, and/or other suitable road conditions) and/or various steering maneuvers (e.g., such as steering on curves and/or emergency steering maneuvers), may reduce vehicle stability, which may result in undesirable steering feel, loss of steering control, and/or the like.

Accordingly, systems and methods, such as those described herein, configured to provide vehicle grip assist to stabilize steering control, may be desirable. In some embodiments, the systems and methods described herein may be configured to prevent loss of control in curves and emergency steering maneuvers by stabilizing the vehicle, in response to the vehicle beginning to veer off the intended path.

The systems and methods described herein may be configured to provide vehicle directional stability by applying and adjusting the steering to direct the vehicle to the intended direction. The systems and methods described herein may be configured to use sensors to determine when the vehicle is not under the control.

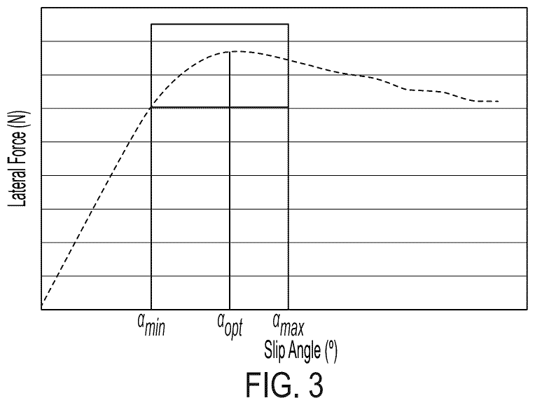

The systems and methods described herein may be configured to provide a vehicle stability control system that uses SbW technology to enhance vehicle grip and stability on the road. The systems and methods described herein may be configured to maintain a slip angle of the tires or roadwheels of the vehicle within a predefined range to maximize lateral force of the roadwheels and prevent loss of grip. The systems and methods described herein may be configured to adjusts a steering angle to keep the vehicle within an optimal slip angle range for a given road surface, as is generally illustrated in FIG. 3. The systems and methods described herein may be configured to improve the grip and stability of the vehicle on the road, reducing the likelihood of the vehicle skidding or spinning out of control.

The systems and methods described herein may be configured to use a front axle (e.g., SbW) or rear axle (e.g., rear steer) steering system. The systems and methods described herein may be configured to use SbW technology for precise and responsive steering. The systems and methods described herein may be configured to allow for relatively faster and relatively more precise adjustments to the steering angle. The systems and methods described herein may be configured to adjust the steering angle based on various factors. The systems and methods described herein may be configured to maintain the vehicle within the optimal slip angle range for a given surface. The systems and methods described herein may be configured to improve vehicle stability and grip on the road. The systems and methods described herein may be configured to provide a vehicle operator with relatively higher confidence and control. The systems and methods described herein may be configured to use of advanced technology and algorithms.

In some embodiments, the systems and methods described herein may be configured to provide vehicle stability control. For example, the systems and methods described herein may be configured to determine a first slip angle of at least one roadwheel of a vehicle. The systems and methods described herein may be configured to determine whether the first slip angle is greater than or equal to a first slip angle threshold. The systems and methods described herein may be configured to, in response to a determination that the first slip angle is greater than or equal to the first slip angle threshold, control at least one aspect of a steering system (e.g., which may include a front axle SbW steering system a rear axle SbW steering system, or any other suitable steering system) of the vehicle to maintain a steering angle. Alternatively, the systems and methods described herein may be configured to, in response to a determination that the first slip angle is less than the first slip angle threshold, control the at least one aspect of the steering system of the vehicle to increase the steering angle.

The systems and methods described herein may be configured to determine a second slip angle of the at least one roadwheel of the vehicle. The systems and methods described herein may be configured to determine whether the second slip angle is greater than or equal to a second slip angle threshold. The systems and methods described herein may be configured to, in response to a determination that the second slip angle is greater than or equal to the second slip angle threshold, control the at least one aspect of the steering system of the vehicle to decrease the steering angle. Alternatively, the systems and methods described herein may be configured to, in response to a determination that the second slip angle is less than the second slip angle threshold, control the at least one aspect of the steering system of the vehicle to maintain the steering angle.

The systems and methods described herein may be configured to determine whether a third slip angle of the at least one roadwheel of the vehicle is less than the first slip angle threshold. The systems and methods described herein may be configured to, in response to the third slip angle being less than the first slip angle threshold, control the at least one aspect of the steering system of the vehicle to maintain the steering angle. Alternatively, the systems and methods described herein may be configured to, in response to the third slip angle being greater than or equal to the first slip angle threshold, control the at least one aspect of the steering system of the vehicle to decrease the steering angle.

The systems and methods described herein may be configured to determine whether a fourth slip angle of the at least one roadwheel of the vehicle is greater than a third slip angle threshold. The systems and methods described herein may be configured to, in response to a determination that the fourth slip angle is greater than the third slip angle threshold, control the at least one aspect of the steering system of the vehicle to decrease the steering angle. Alternatively, the systems and methods described herein may be configured to, in response to a determination that the fourth slip angle is less than or equal to the third slip angle threshold, control the at least one aspect of the steering system of the vehicle to maintain the steering angle.

The systems and methods described herein may be configured to determine whether a fifth slip angle of the at least one roadwheel of the vehicle is less than the third slip angle threshold. The systems and methods described herein may be configured to, in response to a determination that the fifth slip angle is less than the third slip angle threshold, control the at least one aspect of the steering system of the vehicle to increase the steering angle. Alternatively, the systems and methods described herein may be configured to, in response to a determination that the fifth slip angle is greater than or equal to the third slip angle threshold, control the at least one aspect of the steering system of the vehicle to decrease the steering angle.

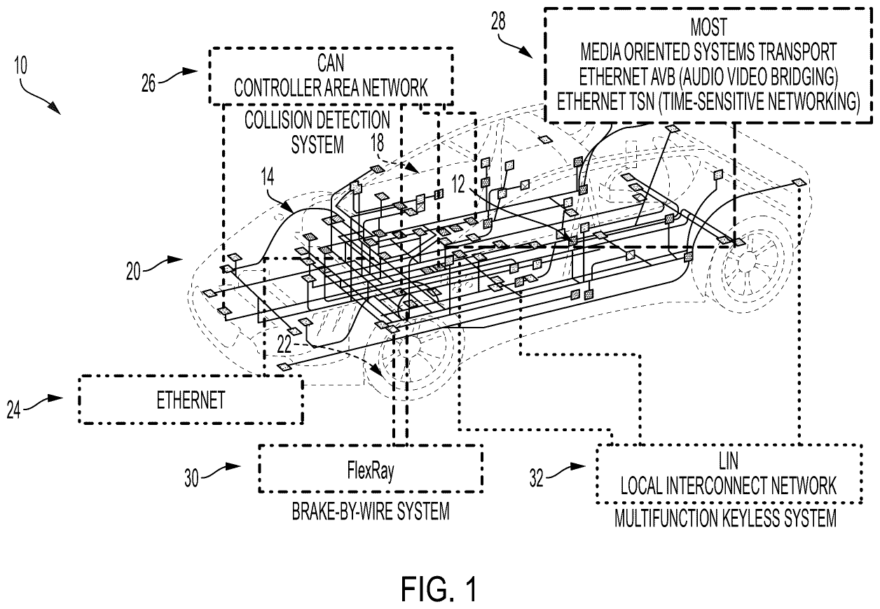

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semiautonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay Component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

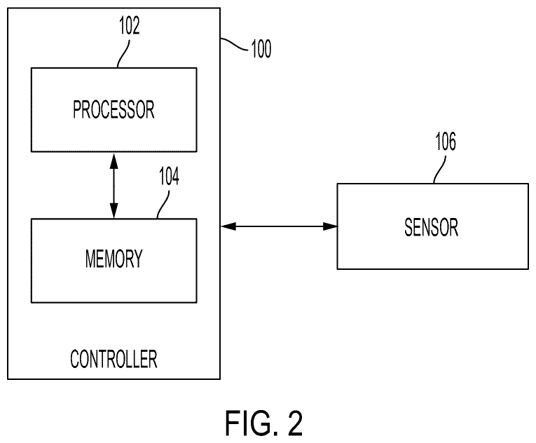

In some embodiments, the vehicle 10 may include a controller, such as controller 100, as is generally illustrated in FIG. 2. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, one or more radar sensors or devices, one or more lidar sensors or devices, one or more sonar sensors or devices, one or more image capturing sensors or devices, other suitable sensors or devices, or a combination thereof. The one or more signals may indicate a handwheel torque, a handwheel angle, a motor velocity, a vehicle speed, other suitable information, or a combination thereof.

In some embodiments, the controller 100 may be configured to provide vehicle stability control. For example, the controller 100 may determine a first slip angle of at least one roadwheel of the vehicle 10. The s controller 100 may determine whether the first slip angle is greater than or equal to a first slip angle threshold. The s controller 100 may, in response to a determination that the first slip angle is greater than or equal to the first slip angle threshold, control at least one aspect of the steering system of the vehicle 10 to maintain a steering angle. Alternatively, the controller 100 may, in response to a determination that the first slip angle is less than the first slip angle threshold, control the at least one aspect of the steering system of the vehicle 10 to increase the steering angle.

The controller 100 may determine a second slip angle of the at least one roadwheel of the vehicle 10. The controller 100 may determine whether the second slip angle is greater than or equal to a second slip angle threshold. The controller 100 may, in response to a determination that the second slip angle is greater than or equal to the second slip angle threshold, control the at least one aspect of the steering system of the vehicle 10 to decrease the steering angle. Alternatively, the controller 100 may, in response to a determination that the second slip angle is less than the second slip angle threshold, control the at least one aspect of the steering system of the vehicle 10 to maintain the steering angle.

The controller 100 may determine whether a third slip angle of the at least one roadwheel of the vehicle 10 is less than the first slip angle threshold. The controller 100 may, in response to the third slip angle being less than the first slip angle threshold, control the at least one aspect of the steering system of the vehicle 10 to maintain the steering angle. Alternatively, the controller 100 may, in response to the third slip angle being greater than or equal to the first slip angle threshold, control the at least one aspect of the steering system of the vehicle 10 to decrease the steering angle.

The controller 100 may determine whether a fourth slip angle of the at least one roadwheel of the vehicle 10 is greater than a third slip angle threshold. The controller 100 may, in response to a determination that the fourth slip angle is greater than the third slip angle threshold, control the at least one aspect of the steering system of the vehicle 10 to decrease the steering angle. Alternatively, the controller 100 may, in response to a determination that the fourth slip angle is less than or equal to the third slip angle threshold, control the at least one aspect of the steering system of the vehicle 10 to maintain the steering angle.

The controller 100 may determine whether a fifth slip angle of the at least one roadwheel of the vehicle 10 is less than the third slip angle threshold. The controller 100 may, in response to a determination that the fifth slip angle is less than the third slip angle threshold, control the at least one aspect of the steering system of the vehicle 10 to increase the steering angle. Alternatively, the controller 100 may, in response to a determination that the fifth slip angle is greater than or equal to the third slip angle threshold, control the at least one aspect of the steering system of the vehicle 10 to decrease the steering angle.

In some embodiments, the controller 100 may perform the methods described herein. However, the methods described herein as performed by the controller 100 are not meant to be limiting, and any type of software executed on a controller or processor can perform the methods described herein without departing from the scope of this disclosure. For example, a controller, such as a processor executing software within a computing device, can perform the methods described herein.

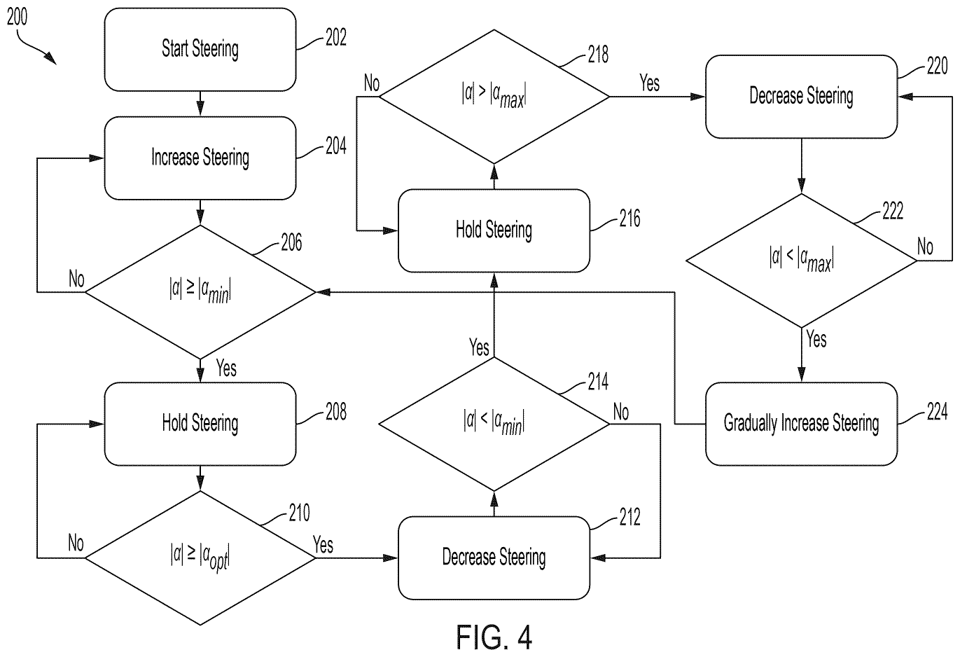

FIG. 4 is a flow diagram generally illustrating a vehicle stability control method 200 according to the principles of the present disclosure. At 202, the method 200 begins steering. For example, the steering system of the vehicle 10 may be engaged by an operator of the vehicle 10 and/or by the controller 100 or other suitable controller or autonomous or semiautonomous feature of the vehicle 10.

At 204, the method 200 increases steering. For example, the controller 100 may increase a steering angle.

At 206, the method 200 determines whether an absolute value of a slip angle of the vehicle 10 is greater than or equal to an absolute value of a minimum slip angle. If the absolute value of the slip angle of the vehicle 10 is greater than or equal to the absolute value of the minimum slip angle, the method 200 continues at 208. Alternatively, the method 200 continues at 204.

At 208, the method 200 holds steering. For example, the controller 100 may maintain the steering angle.

At 210, the method 200 determine whether the absolute value of the slip angle is greater than or equal to an absolute value of an optimum slip angle. If the absolute value of the slip angle is greater than or equal to the absolute value of the optimum slip angle, the method 200 continues at 212. Alternatively, the method 200 continues at 208.

At 212, the method 200 decreases steering. For example, the controller 100 may decrease the steering angle.

At 214, the method 200 determines whether the absolute value of the slip angle of the vehicle 10 is less than the absolute value of the minimum slip angle. If the absolute value of the slip angle of the vehicle 10 is less than the absolute value of the minimum slip angle, the method 200 continues at 216. Alternatively, the method 200 continues at 212.

At 216, the method 200 holds steering. For example, the controller 100 may maintain the steering angle.

At 218, the method 200 determine whether the absolute value of the slip angle is greater than an absolute value of a maximum slip angle. If the absolute value of the slip angle is greater than the absolute value of the maximum slip angle, the method 200 continues at 220. Alternately, the method 200 continues at 216.

At 220, 200 decreases steering. For example, the controller 100 may decrease the steering angle.

At 222, the method 200 determine whether the absolute value of the slip angle is less than the absolute value of the maximum slip angle. If the absolute value of the slip angle is less than the absolute value of the maximum slip angle, the method 200 continues at 224. Alternately, the method 200 continues at 220.

At 224, the method 200 gradually increases steering. For example, the controller 100 may gradually increase the steering angle (e.g., which may include increasing the steering angle according to a calibrated steering angle increase rate).

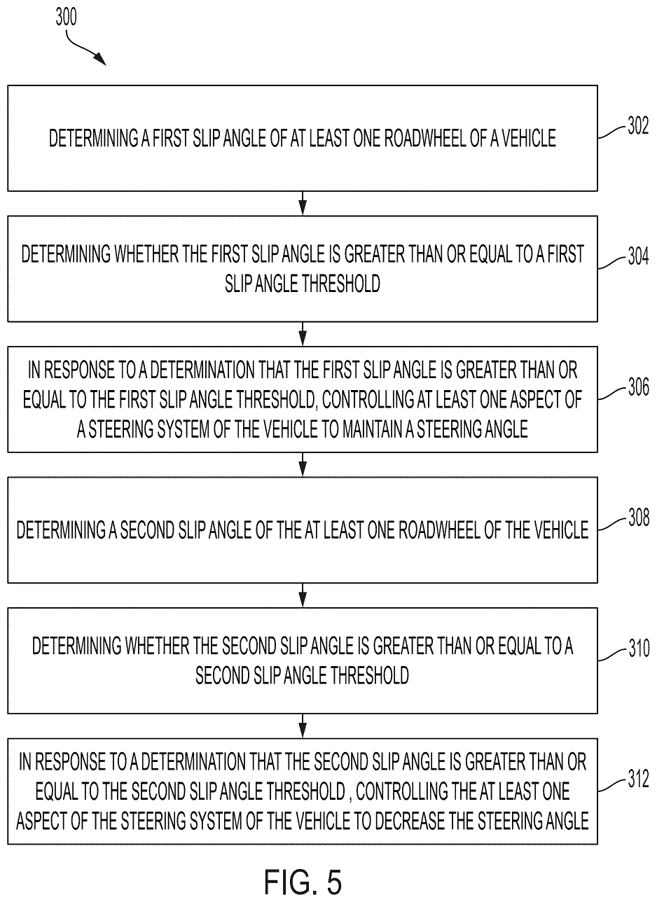

FIG. 5 is a flow diagram generally illustrating an alternative vehicle stability control method 300 according to the principles of the present disclosure. At 302, the method 300 determines a first slip angle of at least one roadwheel of a vehicle.

At 304, the method 300 determines whether the first slip angle is greater than or equal to a first slip angle threshold.

At 306, the method 300, in response to a determination that the first slip angle is greater than or equal to the first slip angle threshold, controls at least one aspect of a steering system of the vehicle to maintain a steering angle.

At 308, the method 300 determines a second slip angle of the at least one roadwheel of the vehicle.

At 310, the method 300 determines whether the second slip angle is greater than or equal to a second slip angle threshold.

At 312, the method 300, in response to a determination that the second slip angle is greater than or equal to the second slip angle threshold, controls the at least one aspect of the steering system of the vehicle to decrease the steering angle.

In some embodiments, a method for vehicle stability control includes determining a first slip angle of at least one roadwheel of a vehicle, determining whether the first slip angle is greater than or equal to a first slip angle threshold, and, in response to a determination that the first slip angle is greater than or equal to the first slip angle threshold, controlling at least one aspect of a steering system of the vehicle to maintain a steering angle. The method also includes determining a second slip angle of the at least one roadwheel of the vehicle, determining whether the second slip angle is greater than or equal to a second slip angle threshold, and, in response to a determination that the second slip angle is greater than or equal to the second slip angle threshold, controlling the at least one aspect of the steering system of the vehicle to decrease the steering angle.

In some embodiments, the method also includes, in response to a determination that the first slip angle is less than the first slip angle threshold, controlling the at least one aspect of the steering system of the vehicle to increase the steering angle. In some embodiments, the method also includes, in response to a determination that the second slip angle is less than the second slip angle threshold, controlling the at least one aspect of the steering system of the vehicle to maintain the steering angle. In some embodiments, the method also includes determining whether a third slip angle of the at least one roadwheel of the vehicle is less than the first slip angle threshold, and, in response to the third slip angle being less than the first slip angle threshold, controlling the at least one aspect of the steering system of the vehicle to maintain the steering angle. In some embodiments, the method also includes, in response to the third slip angle being greater than or equal to the first slip angle threshold, controlling the at least one aspect of the steering system of the vehicle to decrease the steering angle. In some embodiments, the method also includes determining whether a fourth slip angle of the at least one roadwheel of the vehicle is greater than a third slip angle threshold, and, in response to a determination that the fourth slip angle is greater than the third slip angle threshold, controlling the at least one aspect of the steering system of the vehicle to decrease the steering angle. In some embodiments, the method also includes, in response to a determination that the fourth slip angle is less than or equal to the third slip angle threshold, controlling the at least one aspect of the steering system of the vehicle to maintain the steering angle. In some embodiments, the method also includes determining whether a fifth slip angle of the at least one roadwheel of the vehicle is less than the third slip angle threshold, and, in response to a determination that the fifth slip angle is less than the third slip angle threshold, controlling the at least one aspect of the steering system of the vehicle to increase the steering angle. In some embodiments, the method also includes, in response to a determination that the fifth slip angle is greater than or equal to the third slip angle threshold, controlling the at least one aspect of the steering system of the vehicle to decrease the steering angle. In some embodiments, the steering system includes steer-by-wire steering system. In some embodiments, the steering system includes a front axle steer-by-wire steering system. In some embodiments, the steering system includes a rear axle steer-by-wire steering system.

In some embodiments, a system for vehicle stability control includes a processor, and a memory. The memory includes instructions that, when executed by the processor, cause the processor to: determine a first slip angle of at least one roadwheel of a vehicle; determine whether the first slip angle is greater than or equal to a first slip angle threshold; in response to a determination that the first slip angle is greater than or equal to the first slip angle threshold, control at least one aspect of a steering system of the vehicle to maintain a steering angle; determine a second slip angle of the at least one roadwheel of the vehicle; determine whether the second slip angle is greater than or equal to a second slip angle threshold; and, in response to a determination that the second slip angle is greater than or equal to the second slip angle threshold, control the at least one aspect of the steering system of the vehicle to decrease the steering angle.

In some embodiments, the instructions further cause the processor to, in response to a determination that the first slip angle is less than the first slip angle threshold, control the at least one aspect of the steering system of the vehicle to increase the steering angle. In some embodiments, the instructions further cause the processor to, in response to a determination that the second slip angle is less than the second slip angle threshold, control the at least one aspect of the steering system of the vehicle to maintain the steering angle. In some embodiments, the instructions further cause the processor to: determine whether a third slip angle of the at least one roadwheel of the vehicle is less than the first slip angle threshold; and, in response to the third slip angle being less than the first slip angle threshold, control the at least one aspect of the steering system of the vehicle to maintain the steering angle. In some embodiments, the instructions further cause the processor to, in response to the third slip angle being greater than or equal to the first slip angle threshold, control the at least one aspect of the steering system of the vehicle to decrease the steering angle. In some embodiments, the instructions further cause the processor to: determine whether a fourth slip angle of the at least one roadwheel of the vehicle is greater than a third slip angle threshold; in response to a determination that the fourth slip angle is greater than the third slip angle threshold, control the at least one aspect of the steering system of the vehicle to decrease the steering angle; and, in response to a determination that the fourth slip angle is less than or equal to the third slip angle threshold, control the at least one aspect of the steering system of the vehicle to maintain the steering angle. In some embodiments, the instructions further cause the processor to: determine whether a fifth slip angle of the at least one roadwheel of the vehicle is less than the third slip angle threshold; in response to a determination that the fifth slip angle is less than the third slip angle threshold, control the at least one aspect of the steering system of the vehicle to increase the steering angle; and, in response to a determination that the fifth slip angle is greater than or equal to the third slip angle threshold, control the at least one aspect of the steering system of the vehicle to decrease the steering angle.

In some embodiments, an apparatus for vehicle stability control includes a controller configured to: in response to a determination that a first slip angle is greater than or equal to a first slip angle threshold, control at least one aspect of a steering system of the vehicle to maintain a steering angle; in response to a determination that a second slip angle is greater than or equal to a second slip angle threshold, control the at least one aspect of the steering system of the vehicle to decrease the steering angle; in response to a third slip angle being less than the first slip angle threshold, control the at least one aspect of the steering system of the vehicle to maintain the steering angle; in response to a determination that a fourth slip angle is greater than a third slip angle threshold, control the at least one aspect of the steering system of the vehicle to decrease the steering angle; and, in response to a determination that a fifth slip angle is less than the third slip angle threshold, control the at least one aspect of the steering system of the vehicle to increase the steering angle.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. A method for vehicle stability control, the method comprising:
determining a first slip angle of at least one roadwheel of a vehicle;
determining whether the first slip angle is greater than or equal to a first slip angle threshold;
in response to a determination that the first slip angle is greater than or equal to the first slip angle threshold, controlling at least one aspect of a steering system of the vehicle to maintain a steering angle;
determining a second slip angle of the at least one roadwheel of the vehicle;
determining whether the second slip angle is greater than or equal to a second slip angle threshold; and
in response to a determination that the second slip angle is greater than or equal to the second slip angle threshold, controlling the at least one aspect of the steering system of the vehicle to decrease the steering angle.

2. The method of claim 1, further comprising, in response to a determination that the first slip angle is less than the first slip angle threshold, controlling the at least one aspect of the steering system of the vehicle to increase the steering angle.

3. The method of claim 1, further comprising, in response to a determination that the second slip angle is less than the second slip angle threshold, controlling the at least one aspect of the steering system of the vehicle to maintain the steering angle.

4. The method of claim 1, further comprising:
determining whether a third slip angle of the at least one roadwheel of the vehicle is less than the first slip angle threshold; and
in response to the third slip angle being less than the first slip angle threshold, controlling the at least one aspect of the steering system of the vehicle to maintain the steering angle.

5. The method of claim 4, further comprising, in response to the third slip angle being greater than or equal to the first slip angle threshold, controlling the at least one aspect of the steering system of the vehicle to decrease the steering angle.

6. The method of claim 4, further comprising:
determining whether a fourth slip angle of the at least one roadwheel of the vehicle is greater than a third slip angle threshold; and
in response to a determination that the fourth slip angle is greater than the third slip angle threshold, controlling the at least one aspect of the steering system of the vehicle to decrease the steering angle.

7. The method of claim 6, further comprising, in response to a determination that the fourth slip angle is less than or equal to the third slip angle threshold, controlling the at least one aspect of the steering system of the vehicle to maintain the steering angle.

8. The method of claim 7, further comprising:
determining whether a fifth slip angle of the at least one roadwheel of the vehicle is less than the third slip angle threshold; and
in response to a determination that the fifth slip angle is less than the third slip angle threshold, controlling the at least one aspect of the steering system of the vehicle to increase the steering angle.

9. The method of claim 8, further comprising, in response to a determination that the fifth slip angle is greater than or equal to the third slip angle threshold, controlling the at least one aspect of the steering system of the vehicle to decrease the steering angle.

10. The method of claim 1, wherein the steering system includes steer-by-wire steering system.

11. The method of claim 1, wherein the steering system includes a front axle steer-by-wire steering system.

12. The method of claim 1, wherein the steering system includes a rear axle steer-by-wire steering system.

13. A system for vehicle stability control, the system comprising:
a processor; and
a memory including instructions that, when executed by the processor, cause the processor to:
determine a first slip angle of at least one roadwheel of a vehicle;
determine whether the first slip angle is greater than or equal to a first slip angle threshold;
in response to a determination that the first slip angle is greater than or equal to the first slip angle threshold, control at least one aspect of a steering system of the vehicle to maintain a steering angle;
determine a second slip angle of the at least one roadwheel of the vehicle;
determine whether the second slip angle is greater than or equal to a second slip angle threshold; and
in response to a determination that the second slip angle is greater than or equal to the second slip angle threshold, control the at least one aspect of the steering system of the vehicle to decrease the steering angle.

14. The system of claim 13, wherein the instructions further cause the processor to, in response to a determination that the first slip angle is less than the first slip angle threshold, control the at least one aspect of the steering system of the vehicle to increase the steering angle.

15. The system of claim 13, wherein the instructions further cause the processor to, in response to a determination that the second slip angle is less than the second slip angle threshold, control the at least one aspect of the steering system of the vehicle to maintain the steering angle.

16. The system of claim 13, wherein the instructions further cause the processor to:
determine whether a third slip angle of the at least one roadwheel of the vehicle is less than the first slip angle threshold; and
in response to the third slip angle being less than the first slip angle threshold, control the at least one aspect of the steering system of the vehicle to maintain the steering angle.

17. The system of claim 16, wherein the instructions further cause the processor to, in response to the third slip angle being greater than or equal to the first slip angle threshold, control the at least one aspect of the steering system of the vehicle to decrease the steering angle.

18. The system of claim 16, wherein the instructions further cause the processor to:
determine whether a fourth slip angle of the at least one roadwheel of the vehicle is greater than a third slip angle threshold;
in response to a determination that the fourth slip angle is greater than the third slip angle threshold, control the at least one aspect of the steering system of the vehicle to decrease the steering angle; and
in response to a determination that the fourth slip angle is less than or equal to the third slip angle threshold, control the at least one aspect of the steering system of the vehicle to maintain the steering angle.

19. The system of claim 18, wherein the instructions further cause the processor to:
determine whether a fifth slip angle of the at least one roadwheel of the vehicle is less than the third slip angle threshold;
in response to a determination that the fifth slip angle is less than the third slip angle threshold, control the at least one aspect of the steering system of the vehicle to increase the steering angle; and
in response to a determination that the fifth slip angle is greater than or equal to the third slip angle threshold, control the at least one aspect of the steering system of the vehicle to decrease the steering angle.

20. An apparatus for vehicle stability control, the apparatus comprising:
a controller configured to:
in response to a determination that a first slip angle is greater than or equal to a first slip angle threshold, control at least one aspect of a steering system of the vehicle to maintain a steering angle;
in response to a determination that a second slip angle is greater than or equal to a second slip angle threshold, control the at least one aspect of the steering system of the vehicle to decrease the steering angle;
in response to a third slip angle being less than the first slip angle threshold, control the at least one aspect of the steering system of the vehicle to maintain the steering angle;
in response to a determination that a fourth slip angle is greater than a third slip angle threshold, control the at least one aspect of the steering system of the vehicle to decrease the steering angle; and
in response to a determination that a fifth slip angle is less than the third slip angle threshold, control the at least one aspect of the steering system of the vehicle to increase the steering angle.
